(19) United States
(12) Patent Application Publication
(10) Pub. No.: US 2006/0156857 A1
(43) Pub. Date: Jul. 20, 2006

(54) Retractable support crank method and apparatus

(75) Inventors: Timothy S. Turner, Milwaukie, OR (US); Gary M. Scott, Milwaukie, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Burns Bros., Inc.

(21) Appl. No.: 11/330,978

(22) Filed: Jan. 11, 2006

Related U.S. Application Data
(60) Provisional application No. 60/645,493, filed on Jan. 19, 2005.
(60) Provisional application No. 60/667,268, filed on Mar. 31, 2005.

(51) Int. Cl. G05G 1/00

(52) U.S. Cl. 74/545

(57) ABSTRACT

A retractable support crank is provided that includes a first handle piece adapted to be connected to a driving rod, and a second handle piece rotationally coupled to the first handle piece. The second handle piece being adapted to rotate from a high-speed position to a high leverage position by manipulating a releasable locking mechanism coupled to the first and second handle positions.

### RELATED APPLICATIONS

This application claims the benefit of U.S. Provisional Patent Application Ser. No. 60/645,943 entitled RETRACTABLE SUPPORT CRANK METHOD AND APPARATUS, filed Jan. 19, 2005, and U.S. Provisional Patent Application Ser. No. 60/667,268 entitled RETRACTABLE SUPPORT CRANK CONNECTOR METHOD AND APPARATUS, filed Mar. 31, 2005.

### FIELD OF THE INVENTION

Embodiments of the present invention relate to the field of retractable support cranks, sometimes referred to as landing gear cranks, which may be typically found on tractor trailers and other large machines, and specifically pertain to an improved hand crank for raising and lowering landing gear by accommodating both high leverage and high-speed cranking operations.

### BACKGROUND

Current hand cranks are usually of a single piece with a single handgrip to facilitate the cranking operation. The crank must have a large enough offset from the crank axis of rotation or centerline to enable an operator to be able to lift a loaded trailer. These existing designs are a compromise between being too long to turn rapidly and too short to exert maximum leverage. Whether the required cranking effort is high or low, the single larger offset requires the operator to bend up and down while turning the crank, stressing the back and shoulders and causing excessive fatigue.

Lowering the landing gear requires little effort as its weight aids the process. Turning the long crank is inefficient so many drivers will get the crank spinning rapidly with one finger in the middle of the offset arm. This is very dangerous, as their arm is in the middle of the spinning grip and many drivers have been hit and seriously injured.

While some cranks may have multiple handles, or may have two or more handle positions, they require cumbersome multi-part jaw connections that allow for the crank to be moved from one position to another position.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIGS. 1A and 1B illustrate a side views of a retractable support crank in accordance with an embodiment of the present invention;

FIGS. 2A and 2B illustrates side views of an example use of the retractable support crank in accordance with embodiments of the present invention;

FIG. 3 illustrates a partial sectional view of the retractable support crank in accordance with embodiments of the present invention; and

FIGS. 4A through 4G illustrate detailed views showing a connection end of the retractable support crank in accordance with embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The following description may include terms such as inner, outer, under, between, upward, downward, outward, inward, and the like, which are used for descriptive purposes only and are not to be construed as limiting. That is, these terms are terms that are relative only to a point of reference and are not meant to be interpreted as limitations but are, instead, included in the following description to facilitate understanding of the various aspects of the invention.

The phrase “in one embodiment” may be used repeatedly. The phrase generally does not refer to the same embodiment; however, it may. The terms “comprising,” “having,” and “including” are synonymous, unless the context dictates otherwise.

The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B)”; that is, A is optional.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

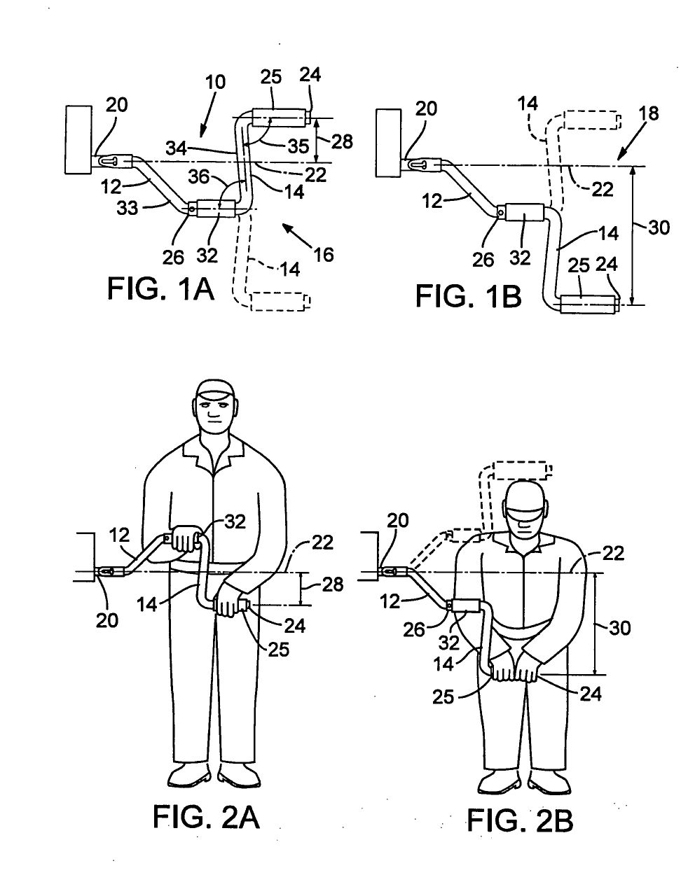

FIG. 1A and FIG. 1B illustrate side views illustrating an embodiment of the invention. A crank 10, for example, a retractable support crank, may include a first handle piece 12 and a second handle piece 14. Crank 10 may have a first configuration 16 as illustrated in FIG. 1A, and a second configuration 18 as illustrated in FIG. 1B.

The first handle piece 12 may be adapted to be connected to a driving rod 20, which may be adapted to drive a landing gear raising and lowering mechanism, such as a gear box, hydraulically actuated device, and the like. The crank 10 may be adapted to rotate about an axis 22, which may be coaxial with the driving rod 20, and thus may be adapted to drive the driving rod 20 for rotation. The second handle piece 14 may have a first end 24, for example, a graspable first end, which may include a first hand grip portion 25. Second handle piece 14 may also have a second end 26, which may be adapted to be connected to the first handle piece 12.

When in the first configuration 16, the first end 24 may be an offset or first radial distance 28 from axis 22. When in the second configuration 18 the first end 24 may be a second radial distance 30 from axis 22. The first configuration 16 may be referred to as a high-speed configuration, in that the crank may be rapidly rotated by an operator. Various embodiments of the present invention may include a hand crank having at least two hand gripable portions that may allow an operator to more ergonomically and safely operate the hand crank. In one embodiment, the offset or first radial distance 28 between the first hand grip portion 25 and the axis 22 is substantially the same as the distance between the second hand grip portion and the axis 22. In other embodiments, the offset distances may be different.

FIG. 2A illustrates one embodiment according to the invention wherein the crank 10 is in the first configuration 16 and is adapted to allow an operator to grip the first hand grip portion 25 of the crank 10 in a first hand and to grip the second hand grip portion 32 in a second hand. The operator may the use both hands in a rapid, yet controlled fashion to lower the landing gear, as a great deal of leverage is not required. The operator may also use both hands and arms instead of one when raising the landing gear to the stowed position, which again does not require a great amount of leverage. Whether raising or lowering, the first configuration not only can provide increased control and increased speed compared to a standard crank, but may also allow a natural upright operating position significantly reducing stress and fatigue. In one embodiment, one or both of the first and second hand grip portions 25/32 may be adapted to rotate on the respective first and second handle pieces 12/14 such that the operator may maintain a firm non-sliding grip when rotating the crank 10.

Referring again to FIG. 1A the second hand gripable portion 32 may be adapted to be coupled to the driving rod 20 via a first connecting member 33 and may be offset from the rotation axis 22. The first hand gripable portion 25 may be offset from the rotation axis 22 in a direction opposite that of the second hand gripable portion 32. A second connecting member 34 may be adapted to couple the first hand gripable portion 25 to the second hand gripable portion 32 such that the first hand gripable portion 25 makes an angle 35 with the second connecting member 34 of less than or substantially equal to 105 degrees, and the second hand gripable portion 32 makes an angle 36 with the second connecting member 34 of less than or substantially equal to a 105 degrees. In one embodiment, the second connecting member may be fixedly connected to the fist hand gripable portion for high speed operation, whereas in another embodiment, there may be a releasable coupling between the two to allow for switching from the high speed to high leverage configuration.

In one embodiment one or both of the first hand gripable portion 25 and the second hand gripable portion 32 may make an angle 35/36 with the second connecting member 34 of less than or substantially equal to 90 degrees. Various embodiments may be ergonomically correct in that they may be adapted to keep an operators hands in front and close to the body, and may require larger muscle groups to be utilized to operate, rather that smaller muscle groups. Further, such a configuration necessarily limits the amount of protrusion the hand crank may have from the side of, for example, a tractor trailer. And, the hand gripable portions may be kept closer to the connecting drive shaft, which may enhance stability during the raising and lowering operation, and reduce the bending tendency and wobble that may be encountered if the hand grippable portions were extended at larger angles.

FIG. 2B illustrates a crank in accordance with the present invention wherein the crank 10 may be in the second configuration 18 such that the second end 24 may be a maximum distance away from the axis 22. This may be considered a high leverage configuration, as the greater offset or second radial distance 30 from the first hand grip portion and the axis 22 will enable the operator to lift heavier loads by virtue of the greater leverage, such as raising a loaded tractor trailer once the landing gear is on the ground. In various embodiments the second handle piece 14 may be oriented at various angles relative the first handle piece 12 providing different intermediate configurations and various amounts of leverage.

A releasable locking mechanism may be coupled between the first and second handle pieces 12/14, which may allow for the second handle piece 14 to be reoriented relative the first handle piece 12 from the first configuration 16 to the second configuration 18. The releasable locking mechanism may also allow locking of the pieces with respect to each other in a desired position. In one embodiment, the releasable locking mechanism can releasably lock the second handle piece 14 in either a high speed or high leverage position, with respect to the first handle piece 12 and the axis 22 of rotation.

The releasable locking mechanism may include a number of different devices, including, but not limited to button biased connectors, squeeze spring pin connectors, fixed pin connectors, barrel thread connectors, and the like. Embodiments of the present invention may include locking mechanisms that do not require the use of tools in order to facilitate quick and hassle free locking and unlocking.

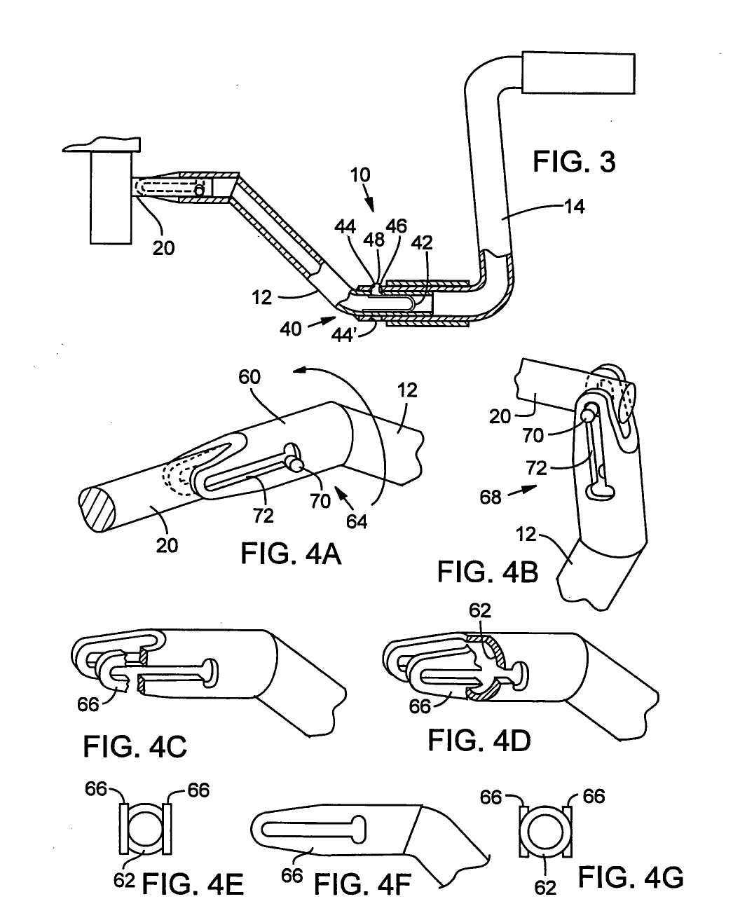

For example, FIG. 3 is a partial cross-sectional view illustrating one embodiment according to the invention wherein a crank 10 includes a releasable locking mechanism 40 comprising a bias member 42 such as a leaf spring or the like, disposed within the first handle piece 12. The first handle piece 12 and the second handle piece 14 may each include bores 44 and 46 adapted to receive a squeeze button 48. The squeeze button 48 may be adapted to be squeezed against the biasing member 42, thereby freeing the second handle piece 14 for rotation about the first handle piece 12. The second handle piece 14 may also include at least one additional bore 44′ adapted to receive the squeeze button 48 and located to lock the second handle piece 14 in the second configuration 18.

In various embodiments, the second handle piece 14 may be adapted to engage the first handle piece in a telescoping manner, such that the second handle piece has an inner diameter that is larger than the outer diameter of the first handle piece. In other embodiments, the first handle piece and the second handle piece may join at a rotatable union that is adapted to allow one handle piece to rotate about the other.

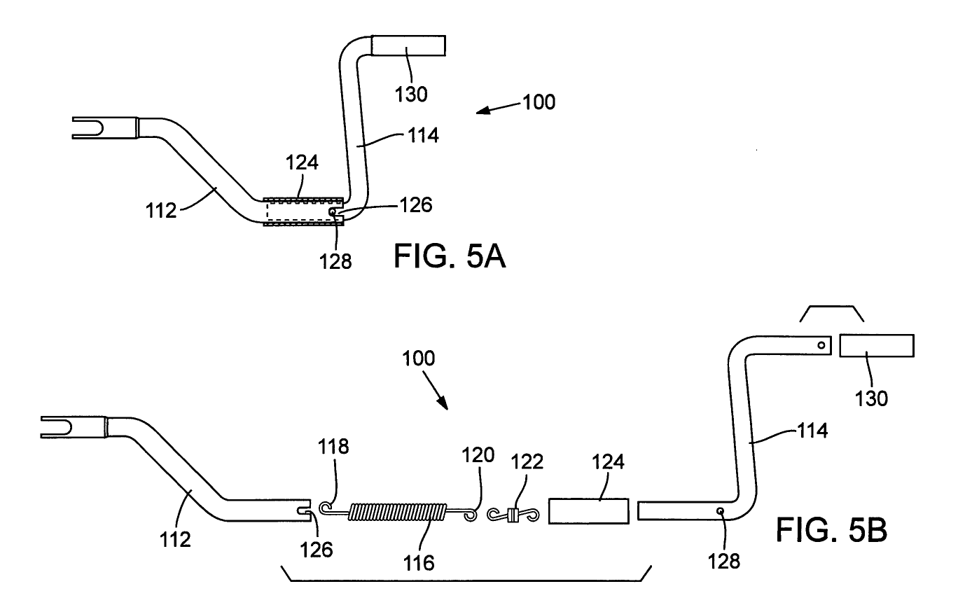

FIGS. 4A and 4B are detailed perspective views, FIGS. 4C and 4D are partial sectional views, and FIGS. 4E, 4F, and 4G are respective front, side, and rear views illustrating a support crank in accordance with one embodiment of the invention. The first handle piece 12 may have a connection end 60 having a tubular portion 62 adapted to fit telescopically over the driving rod 20. In an engaged position 64, as illustrated in FIG. 4A, the tubular portion 62 sufficiently encloses the driving rod 20 for stability and rigidity when driving the driving rod 20 for rotation.

The connection end 60 may also include a straight portion 66 adapted to pivot relative the driving rod in a stored position 68 as illustrated in FIG. 4B. The connection end 60 may be retractable from the engaged position 64 to the stored position 68.

The connection end 60 may include a slot 72 disposed therein that extends from the straight portion 66 to the tubular portion 62. The driving rod 20 may include a protrusion 70 that may be adapted to extend into the slot 72, to provide a rotation resistance when the driving rod is being rotated by the first handle piece 12 (operational position), as well as guide the connection end 60 while retracting from an operational position to the stored position, and to provide a pivot about which the first handle piece may pivot.

FIG. 5A illustrate a side view and FIG. 5B an exploded side view illustrating an embodiment of the invention. A crank 100, may include a first handle piece 112 and a second handle piece 114 adapted to be coupled together by for example a telescopic coupling. The handle pieces 112/114 may be biased to a joined position as shown in FIG. 5B by for example a spring 116. The handle pieces 112/114 may be hollow and adapted to house the spring 116. The spring 116 may include a first end 118 and a second end 120. The first end 118 may be adapted to couple to a pin, hole, or the like (not shown) within the first handle piece 112, to retain the first end. The spring 116 may extend through the first handle piece 112 into the second hand piece 114 and may be coupled to a swivel 122, which may be coupled to second handle piece 114.

In one embodiment the second handle piece 114 may be adapted to be pulled against the spring 116 and repositioned to a second configuration 18 such as that illustrated in FIG. 1B. The grip 124 and/or first handle piece 112 may incldue a slot 126 adapted to receive a protrusion 128 on the second handle piece 114. Such a configuration may releasably lock the second handle piece in one or more configurations such as, but not limited to, the first configuration 16 as illustrated in FIG. 1A, and/or the second configuration 18 as illustrated in FIG. 1B. In one embodiment, a first grip 124 may be positioned over adjoining portions of the handle pieces 112/114 and a second grip 130 may be positioned over an end of the second handle piece 114.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A retractable support crank rotatable about a rotation axis, comprising:
a first handle piece adapted to couple to a driving shaft;
a second handle piece having a graspable first end and a second end coupled to the first handle piece, and the second handle piece having a first position such that the first end is a first radial distance away from the rotation axis, and having a second position such that the first end is a second radial distance away from the rotation axis.

2. The retractable support crank of claim 1, further comprising a releasable locking mechanism adapted to releasably lock the second handle piece in the first position and in the second position, and further adapted to be releasable to allow the second handle piece to be moved from the first position to the second position.

3. The retractable support crank of claim 2 wherein the releasable locking mechanism includes a biased squeeze button adapted to engage a correspondingly sized first bore in each of the first handle piece and the second handle piece to cooperatively lock the second handle piece relative the first handle piece in a first position, the squeeze button adapted to retract from the first bore of the second handle piece to allow the second handle piece to move relative the first handle piece.

4. The retractable support crank of claim 3, wherein the second handle piece includes a second bore engagable by the squeeze button to lock the second handle piece in a second position with respect to the first handle piece.

5. The retractable support crank of claim 1 further comprising a first hand grip portion disposed towards the first end of the second handle piece.

6. The retractable support crank of claim 5 further comprising a second hand grip portion disposed towards the second end of the second handle piece proximal to a junction between the first handle piece and the second handle piece, the first hand grip and the second hand grip being on opposite sides of the rotation axis, the first and second hand grip portions adapted to be grasped with respective two hands for rotation about the rotation axis.

7. The retractable support crank of claim 6, wherein the first hand grip portion and the second hand grip portion include gripable members that are rotatably disposed on the second handle piece.

8. The retractable support crank of claim 1 wherein the first handle piece has a connection end having a tubular portion adapted to fit telescopically over the driving rod in an engaged position and a straight portion adapted to allow the connection end to pivot relative the driving rod into a stored position.

9. The retractable support crank of claim 8 further comprising a protrusion on the driving rod, the connection end defining a slot extending from the straight portion to the tubular portion, the protrusion adapted to extend into the slot, the protrusion guiding the connection end for retraction and the first handle piece for pivoting about the protrusion.

10. The retractable support crank of claim 8 wherein the connection end defines a slot extending from the straight portion to the tubular portion adapted to fit over a protrusion on the driving rod such that the protrusion guides the connection end for retraction and for pivoting about the protrusion.

11. The retractable support crank according to claim 1 further comprising a biasing member adapted to biased the first handle piece and second handle piece towards each other.

12. The retractable support crank according to claim 11 wherein the second handle piece is adapted to be pulled against the biasing member and further adapted to be repositioned from one of the first configuration and the second configuration to the other of the first configuration and the second configuration.

13. A retractable support crank comprising:
a first handle piece adapted for rotation about a rotation axis; and
a second handle piece rotatably disposed about the first handle piece, the second handle piece having a first position relative to the first handle piece such that a first end of the second handle piece is a first radial distance away from the rotation axis and a second end of the second hand is a second distance away from the rotation axis, the second handle piece having a second position relative to the first handle piece such that the first end is a third distance away from the rotation axis.

14. The retractable support crank of claim 13 further comprising a releasable locking mechanism adapted to releasably lock the second handle piece in the first position and in the second position.

15. The retractable support crank of claim 14 wherein the releasable locking mechanism is a selected one of a group consisting of button biased members, barrel connectors, and through pin connectors.

16. The retractable support crank of claim 13, wherein the third radial distance is greater than the first radial distance.

17. The retractable support crank of claim 16, wherein the first radial distance and the second radial distance are substantially equal.

18. A retractable support crank rotatable about a rotation axis comprising:
a second hand gripable portion adapted to be coupled to a driving shaft via a first connecting member and being offset from the rotation axis;
a first hand gripable portion being offset from the rotation axis in a direction opposite that of the first hand gripable portion;
a second connecting member adapted to couple the first hand gripable portion to the second hand gripable portion such that the first hand gripable portion makes an angle with the second connecting member of less than or substantially equal to 105 degrees, and the second hand gripable portion makes an angle with the second connecting member of less than or substantially equal to 105 degrees.

19. The retractable support crank of claim 18 wherein one or both of the first and the second hand gripable portions makes an angle with the second connecting member of less than or substantially equal to 90 degrees.
